(19) United States
(12) Patent Application Publication
(10) Pub. No.: US 2017/0091349 A1
(43) Pub. Date: Mar. 30, 2017

(54) SYSTEM AND METHOD FOR FACILITATING OPTIMIZATION OF SPACE IN A WAREHOUSE

(71) Applicant: HCL Technologies Limited, Noida (IN)

(72) Inventors: Madhusudhan R M, Chennai (IN); Ashar PASHA, Frisco, TX (US)

(21) Appl. No.: 15/051,898

(22) Filed: Feb. 24, 2016

(30) Foreign Application Priority Data
Sep. 24, 2015 (IN) 3040/DEL/2015

(51) Int. Cl. G06F 17/50

(52) U.S. Cl. CPC G06F 17/5004

(57) ABSTRACT

Disclosed is a system and method for facilitating optimization of space in a warehouse. A data capturing module captures dimension data associated to zero or more objects present in a pallet of a plurality of pallets of a pallet rack present in a warehouse. A surface space computation module computes empty surface space in the pallet based on the dimension data and a predefined pallet dimension data associated with the pallet. The surface space computation module further determines whether the empty surface space, in the pallet, is greater or less than a predefined threshold value. A data transmission module transmits data to an external system communicatively coupled with the IoT device, the data indicating the empty surface space, in the pallet, being greater or less than the predefined threshold value thereby facilitating a user to optimize the space in the pallet of the pallet rack present in the warehouse.

### CROSS-REFERENCE TO RELATED APPLICATIONS AND PRIORITY

The present application claims benefit from Indian Complete Patent Application No. 3040/DEL/2015, filed on Sep. 24, 2015, the entirety of which is hereby incorporated by reference.

### TECHNICAL FIELD

The present subject matter described herein, in general, relates to, systems and methods for facilitating optimization of space in a warehouse.

### BACKGROUND

In a supply chain network, a warehouse plays a vital role in receiving and supplying a right product, at a right place, at a right time. It is evident that globalization and emergence of Omni-channel e-commerce platforms have significantly increased the role of the warehouse in the supply chain network. As the warehouse has become essential in the supply chain network, it becomes very important to address the challenges hindering optimal performance in managing the supply chain network. One of the major pain points in optimizing the utilization of space of the warehouse is confronting third-party logistics providers (3PLs) reserving location and/or slots in the warehouse and the utilization of space inside each location. Improper utilization of the space impacts major areas of operations. Some of the areas of operations may include, but are not limited to, scope for increasing the business revenue, lack of visibility on partially utilized locations resulting in poor result warehouse occupancy rate, stock turnaround ratio of the warehouse is affected due to improper utilization of the space, lack of space in the warehouse delays vehicle offloading at the receiving operations, offloading delays lead to increase in vehicle halting hours and vehicle turn-around time.

In addition to the above, currently, it is not possible to optimize warehouse space utilization in real-time. This is because the warehouse operator has to manually scan through each pallet rack in the warehouse to determine empty space in which any additional objects and/or articles may be adjusted in the empty space of the pallet rack.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for facilitating optimization of space in a warehouse and the concepts are further described below in the detailed description.

In one implementation, an Internet of Things (IoT) device for facilitating optimization of space in a warehouse is disclosed. In one aspect, the IoT device may include a processor and a memory coupled to the processor. The processor may execute a plurality of modules stored in the memory. The plurality of modules may include a data capturing module, a surface space computation module, and a data transmission module. The data capturing module may capture dimension data associated to zero or more objects present in a pallet of a plurality of pallets of a pallet rack present in the warehouse. The dimension data indicates area occupied by the zero or more objects in the pallet. The surface space computation module may compute empty surface space in the pallet based on the dimension data and a predefined pallet dimension data associated with the pallet. The data transmission module may transmit data to an external system communicatively coupled with the IoT device. The data indicates the empty surface space, in the pallet, being greater or less than the predefined threshold value thereby facilitating a user to optimize the space in the pallet of the pallet rack present in the warehouse.

In another implementation, a method for facilitating optimization of space in a warehouse is disclosed. In one aspect, dimension data associated to zero or more objects present in a pallet of a plurality of pallets of a pallet rack present in a warehouse may be captured. The dimension data indicates area occupied by the zero or more objects in the pallet. Upon receiving the dimension data, empty surface space in the pallet may be computed based on the dimension data and a predefined pallet dimension data associated with the pallet. Subsequent to the computation of the empty surface space, it may be determined whether the empty surface space, in the pallet, is greater or less than a predefined threshold value. Upon determining, data may be transmitted to an external system communicatively coupled with the IoT device. The data indicates the empty surface space, in the pallet, being greater or less than the predefined threshold value thereby facilitating a user to optimize the space in the pallet of the pallet rack present in the warehouse. In one aspect, one or more steps of the aforementioned method for facilitating optimization of the space in the warehouse is performed by a processor, of the IoT device, using programmed instructions stored in a memory of the IoT device.

In yet another implementation, non-transitory computer readable medium embodying a program executable in a computing device for facilitating optimization of space in a warehouse is disclosed. The program may include a program code for capturing dimension data associated to zero or more objects present in a pallet of a plurality of pallets of a pallet rack present in a warehouse. The dimension data indicates area occupied by the zero or more objects in the pallet. The dimension data may be captured by an Internet of Things (IoT) device. The program may further include a program code for computing empty surface space in the pallet based on the dimension data and a predefined pallet dimension data associated with the pallet. Further, the program may include a program code for determining whether the empty surface space, in the pallet, is greater or less than a predefined threshold value. Furthermore, the program may comprise a program code for transmitting data to an external system communicatively coupled with the IoT device. The data indicates the empty surface space, in the pallet, being greater or less than the predefined threshold value thereby facilitating a user to optimize the space in the pallet of the pallet rack present in the warehouse.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of an Internet of Things (IoT) device for facilitating optimization of space in a warehouse, in accordance with an embodiment of the present subject matter.

FIG. 2 illustrates the IoT device, in accordance with an embodiment of the present subject matter.

FIGS. 3(a) and 3(b) illustrate an example of multiple IoT devices being deployed in multiple pallets for facilitating the optimization of space in each pallet, in accordance with an embodiment of the present subject matter.

FIG. 4 illustrates a method for facilitating optimization of the space in the warehouse, in accordance with an embodiment of the present subject matter.

### DETAILED DESCRIPTION

The present invention will now be described more fully hereinafter with reference to the accompanying drawings and diagrams in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings. Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

It has been observed that, currently, a warehouse operator runs through each pallet rack present in a warehouse to check adequate empty space, if any, is available in a pallet to fit in additional articles or objects in the pallet. Since pallet racks are huge in size, a lot of empty space remains unutilized as the empty space in the pallet racks is not viewable to the warehouse operator and thus optimization of the space in the warehouse is marginal.

In order to eliminate the manual pain for optimizing the space, the present system and method provides a solution for optimizing the space in the warehouse that facilitates location specific current occupancy level in real-time through the use of an Internet of Things (IoT) device. It may be understood that the IoT device may be deployed in a pallet thereby obviating the need of manual monitoring for optimizing the space.

The IoT device facilitates the warehouse operator to optimize space in the warehouse. In order to optimize, initially, dimension data may be captured by the IoT device deployed in a pallet of a pallet rack present in the warehouse. The dimension data may be associated to zero or more objects present in the pallet. The dimension data indicates area occupied by the zero or more objects in the pallet. In one aspect, the dimension data may include, but not limited to, width, depth, and height. Upon capturing the dimension data, empty surface space in the pallet may be computed. The empty surface space may be computed based on the dimension data and a predefined pallet dimension data associated with the pallet. Subsequent to the computation, it may be determined whether the empty surface space is greater or less than a predefined threshold value.

After determining the empty surface space is greater or less than the predefined threshold value, data may be transmitted to an external system (typically a warehouse management system (WMS)) communicatively coupled with the IoT device. The data indicates the empty surface space being greater or less than the predefined threshold value. The external system may then display the pallet in green, on a Graphical User Interface (GUI) of the external system, when the empty surface space is greater than the predefined threshold value. On the other hand, the external system displays the pallet in red on the GUI when the empty surface space is less than the predefined threshold value. The warehouse operator then adjusts the additional articles or objects in the empty free space and thereby optimizes the space in the warehouse.

While aspects of described system and method for facilitating optimization of space in a warehouse and may be implemented in any number of different computing systems, environments, and/or configurations, the embodiments are described in the context of the following exemplary system.

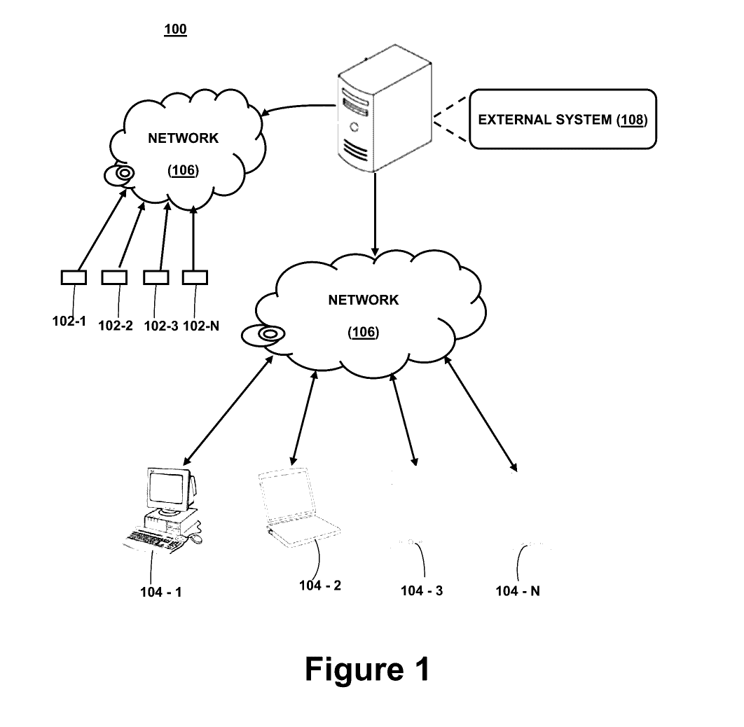

Referring now to FIG. 1, a network implementation 100 of an Internet of Things (IoT) device 102-1, 102-2, 102-3, 102-N, hereinafter referred to as IoT device 102, for facilitating optimization of space in a warehouse is disclosed. In one aspect, the Internet of Things (IoT) device 102 captures dimension data associated to zero or more objects present in a pallet of a plurality of pallets of a pallet rack present in a warehouse. The dimension data indicates area occupied by the zero or more objects in the pallet. Upon capturing the dimension data, the IoT device 102 compute empty surface space in the pallet based on the dimension data and a predefined pallet dimension data associated with the pallet. Upon computation of the empty surface space, the IoT device 102 determines whether the empty surface space is greater or less than a predefined threshold value. Subsequent to the determination, the IoT device 102 transmits data to an external system communicatively coupled with the IoT device. The data indicates the empty surface space, in the pallet, being greater or less than the predefined threshold value thereby facilitating a user to optimize the space in the pallet of the pallet rack present in the warehouse.

Although the present disclosure is explained considering that the IoT device 102 is implemented on at least one of Radio-frequency identification Device (RFID), a telematics device, a wearable device, and a sensor. It will be understood that the IoT device 102 may be communicatively coupled with an external system 108 through a network 106. The external system 108 may be accessed by multiple users through one or more user devices 104-1, 104-2, 104-3, 104-N, collectively referred to as user 104 or stakeholders, hereinafter, or applications residing on the user devices 104. Examples of the user devices 104 may include, but are not limited to, a portable computer, a personal digital assistant, a handheld device, and a workstation. The user devices 104 are communicatively coupled to the external system 108 through the network 106.

In one aspect, the one or more user devices access the external system 108 via an input/output (I/O) interface. The I/O interface may include a variety of software and hardware interfaces, for example, a web interface, a graphical user interface, and the like. The I/O interface may allow the external system 108 to interact with the user directly or through the user devices 104. Further, the I/O interface may enable the external system 108 to communicate with other computing devices, such as web servers and external data servers (not shown). The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

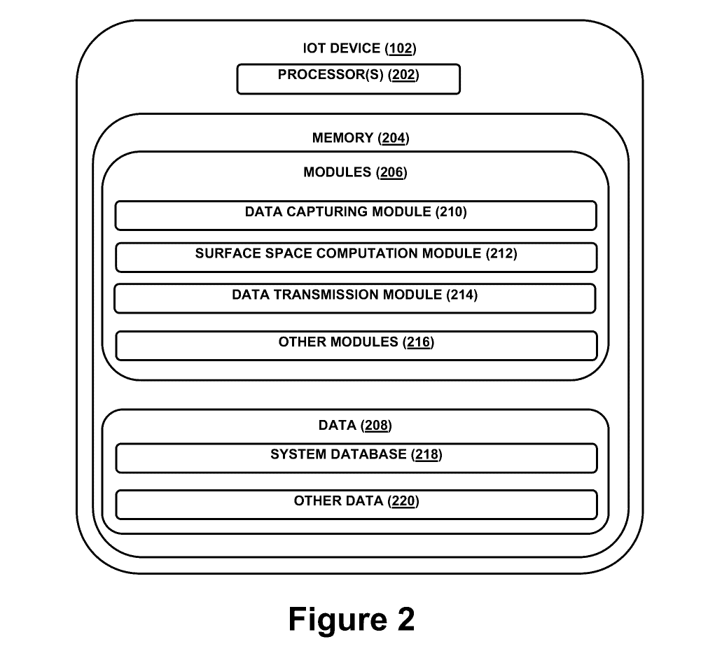

Referring now to FIG. 2, the IoT device 102 is illustrated in accordance with an embodiment of the present subject matter. In one embodiment, the IoT device 102 may include at least one processor 202 and a memory 204. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The memory 204 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 204 may include modules 206 and data 208.

The modules 206 include routines, programs, objects, components, data structures, etc., which perform particular tasks or implement particular abstract data types. In one implementation, the modules 206 may include a data receiving module 210, a surface space computation module 212, a data transmission module 214, and other modules 216. The other modules 216 may include programs or coded instructions that supplement applications and functions of the system 102. The modules 208 described herein may be implemented as software modules that may be executed in the cloud-based computing environment of the IoT device 102.

The data 208, amongst other things, serves as a repository for storing data processed, received, and generated by one or more of the modules 206. The data 208 may also include a system database 218 and other data 220. The other data 220 may include data generated as a result of the execution of one or more modules in the other modules 216.

As there are challenges observed in the existing art, the challenges necessitate the need for facilitating optimization of space in a warehouse. In order to facilitate optimization, a warehouse operator, hereinafter referred to as a user, optimizes the space in the warehouse, may use the client device 104 to access the external system 108 via the I/O interface. The user may register him/her using the I/O interface in order to use the external system 108. In one aspect, the user may access the I/O interface of the external system 108. The external system 108 may be communicatively coupled with the IoT device 102. The system 102 may employ the data capturing module 210, the surface space computation module 212, and the data transmission module 214. The detail functioning of the modules as described below.

It may be understood that the warehouse includes a plurality of pallet racks. Since a pallet rack is huge in size, a lot of empty space remains unutilized as the empty space in the pallet racks is not viewable to the user. Therefore, utilization of the space in the warehouse is highly manual and inefficient. The pallet rack further includes a plurality of pallets for keeping one or more articles of distinct size and shape. Automating conventional processes may increase the efficiency and lead to higher optimization of the space. The IoT device 102 provides an optimized solution for providing location specific occupancy levels of the pallet racks, without manual intervention, in real-time. The IoT device 102 may provide the data points needed in real-time to optimize and thereby increase the level of optimization of the space to drive higher revenues and reduced costs.

In order to optimize the space, initially, the IoT device 102 may be deployed in a pallet of the plurality of pallets of the pallet rack. The IoT device 102 may include, but not limited to, Radio-frequency identification device (RFID), a telematics device, a wearable device, and a sensor. Once the IoT device 102 is deployed, the data capturing module 210 of the IoT device 102 captures dimension data associated to zero or more objects present in the pallet. The dimension data may include, but not limited to, width, depth, and height. The dimension data indicates area occupied by the zero or more objects in the pallet

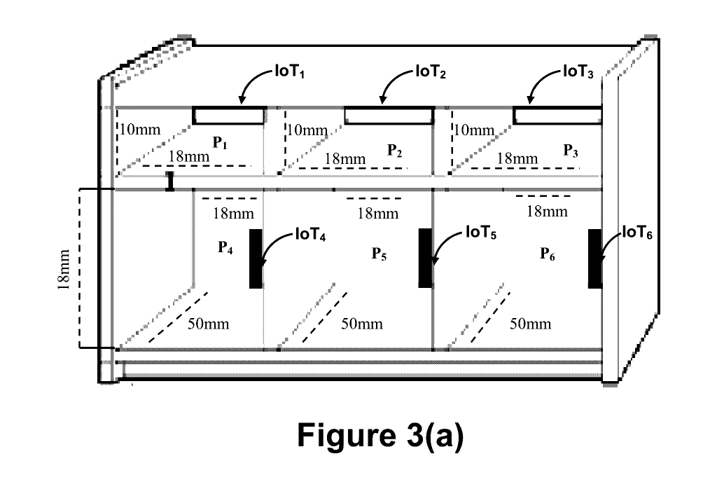

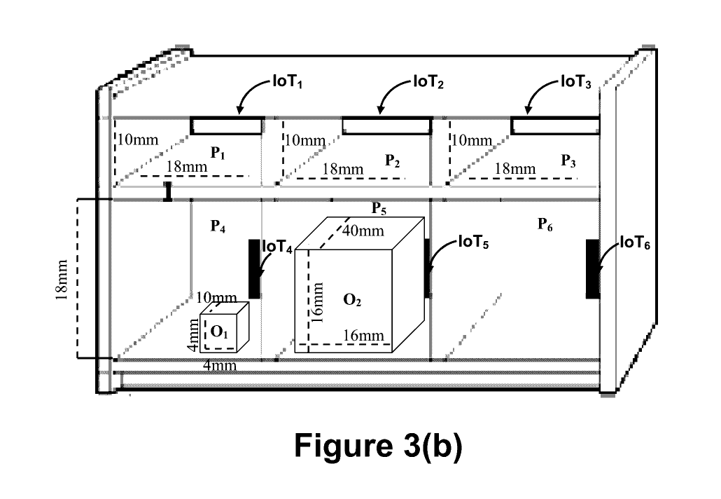

In one example, referring to FIG. 3(a), consider a pallet rack having a plurality of pallets i.e. P₁-P₆ as shown. It is to be understood from the FIG. 3(a) that the IoT device(s) 102 (i.e. IoT₁-IoT₆) is deployed in P₁-P₆ respectively. Further P₁-P₃, is having equal predefined dimension data. On the other hand, P₄-P₆ is having equal predefined dimension data. In an example, the predefined dimension data pertaining to P₄-P₆ are 18 mm width (w), 50 mm depth (d), and 18 mm height (h).

Now referring to FIG. 3(b), it may be observed that P₄ and P₅ contain objects O₁ and O₂. The data capturing module 210 captures the dimension data pertaining to O₁ and O₂ present in P₄ and P₅ respectively. The dimension data associated to O₁ are 4 mm width (w), 4 mm depth (d), and 4 mm height (h). The dimension data associated to O₂ are 16 mm (w), 40 mm depth (d), and 16 mm height (h). In this manner, the dimension data corresponding to each object present in the pallet is captured by the data capturing module 210.

After capturing the dimension data, the surface space computation module 212 compute empty surface space in the pallet. The empty surface space may be computed based on the dimension data and a predefined pallet dimension data associated with the pallet. In one embodiment, the empty surface space may be computed by subtracting the dimension data from the predefined pallet dimension data.

In order to elucidate further, consider the same example as aforementioned. Since the predefined pallet dimension data associated to P₄ are 18 mm width (w), 50 mm depth (d), and 18 mm height (h), the empty surface space in P₄ is computed by subtracting the dimension data associated to O₁ i.e. 4 mm width (w), 4 mm depth (d), and 4 mm height (h) from the 18 mm width (w), 50 mm depth (d), and 18 mm height (h) respectively. Upon subtracting, the empty surface space in P₄ is computed i.e. 14 mm width (w), 46 mm depth (d), and 14 mm height (h). Similarly, the empty surface space in P₅ is computed i.e. 2 mm width (w), 10 mm depth (d), and 2 mm height (h). Since the P₆ is empty, the empty surface space in P₆ is 18 mm width (w), 50 mm depth (d), and 18 mm height (h).

Subsequent to the computation of the empty free space, the surface space computation module 212 further determines whether the empty surface space, in the pallet, is greater or less than a predefined threshold value. For example, consider the predefined threshold value defined for P₄, P₅, and P₆ is 5 mm width (w), 20 mm depth (d), and 5 mm height (h). Based on the predefined threshold value and example mentioned above, the surface space computation module 212 determines that the empty surface space in P₄ and P₆ are greater than the predefined threshold value. The surface space computation module 212 further determines that the empty surface space in P₅ is less than the predefined threshold value.

Subsequently, the data transmission module 214 transmits data to the external system 108 communicatively coupled with the IoT device 102. The data indicates the empty surface space, in the pallet, being greater or less than the predefined threshold value. In one aspect, the external system 108 displays the pallet in green on a Graphical User Interface (GUI) of the external system 108 when the empty surface space is greater than the predefined threshold value. The external system 108, on the other hand, displays the pallet in red on the GUI when the empty surface space is less than the predefined threshold value. The external system 108 displays the pallet in distinct color to bring attention of the user towards the pallet having the empty free space greater the predefined threshold value. Thus, in this manner, the external system 108 displays P₄ and P₆ in green color and P₅ in red color indicating the user that P₄ and P₆ are having the empty free space. The user may then fit in the additional objects, and/or articles in P₄ and P₆ thereby optimizing the space in the warehouse.

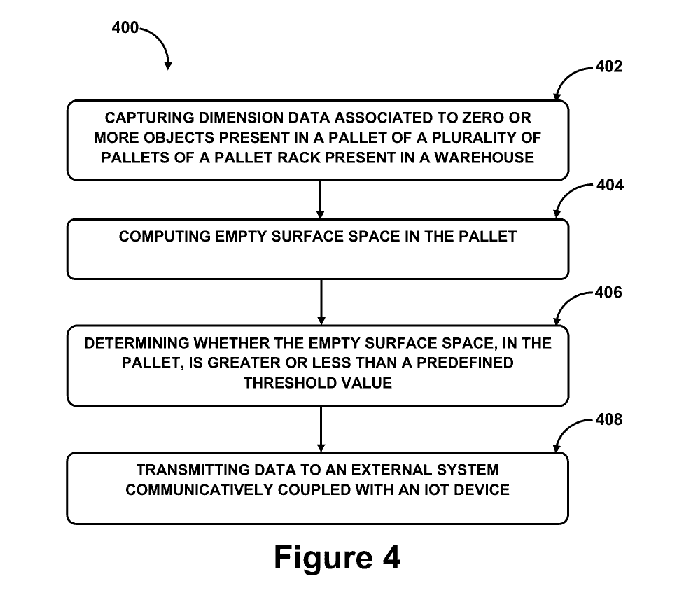

Referring now to FIG. 4, a method 400 for facilitating optimization of space in a warehouse is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the IoT device 102.

At block 402, dimension data associated to zero or more objects present in a pallet of a plurality of pallets of a pallet rack present in a warehouse may be captured. In one embodiment, the dimension data indicates area occupied by the zero or more objects in the pallet. In one implementation, the dimension data may be captured by the data capturing module 210.

At block 404, empty surface space may be computed in the pallet based on the dimension data and a predefined pallet dimension data associated with the pallet. In one embodiment, the empty surface space may be computed by the surface space computation module 212.

At block 406, it may be determined whether the empty surface space, in the pallet, is greater or less than a predefined threshold value. In one embodiment, the empty surface space may be determined by the surface space computation module 212.

At block 408, data may be transmitted to an external system communicatively coupled with the IoT device. The data indicates the empty surface space, in the pallet, being greater or less than the predefined threshold value thereby facilitating a user to optimize the space in the pallet of the pallet rack present in the warehouse. In one embodiment, the data may be transmitted by the data transmission module 214.

Exemplary embodiments discussed above may provide certain advantages. Though not required to practice aspects of the disclosure, these advantages may include those provided by the following features.

Some embodiments enable a system and a method to update space utilization pertaining to a pallet, of a pallet rack, in real-time.

Some embodiments enable a system and a method to provide complete visibility of the warehouse, thereby enabling additional maximum volume handling capabilities by a pallet in the pallet rack.

Although implementations for methods and systems for facilitating optimization of space in a warehouse have been described in language specific to structural features and/or methods, it is to be understood that the appended claims are not necessarily limited to the specific features or methods described. Rather, the specific features and methods are disclosed as examples of implementations for facilitating optimization of space in a warehouse.

We claim:

1. A method for facilitating optimization of space in a warehouse, the method comprising:
capturing, by an Internet of Things device, dimension data associated to zero or more objects present in a pallet of a plurality of pallets of a pallet rack present in a warehouse, wherein the dimension data indicates area occupied by the zero or more objects in the pallet;
computing, by the Internet of Things device, empty surface space in the pallet based on the dimension data and a predefined pallet dimension data associated with the pallet;
determining, by the Internet of Things device, whether the empty surface space, in the pallet, is greater or less than a predefined threshold value; and
transmitting, by the Internet of Things device, data to an external system communicatively coupled with the Internet of Things device, the data indicating the empty surface space being greater or less than the predefined threshold value thereby facilitating a user to optimize the space in the pallet of the pallet rack present in the warehouse.

2. The method of claim 1, wherein the Internet of Things device is at least one of a Radio-frequency identification Device, a telematics device, a wearable device, and a sensor

3. The method of claim 1, wherein the dimension data comprise width, depth, and height.

4. The method of claim 1, wherein the empty surface space is computed by subtracting the dimension data from the predefined pallet dimension data.

5. The method of claim 1, wherein the pallet is displayed in green on a Graphical User Interface of the external system when the empty surface space is greater than the predefined threshold value, and wherein the pallet is displayed in red on the Graphical User Interface when the empty surface space is less than the predefined threshold value.

6. An Internet of Things device for facilitating optimization of space in a warehouse, the Internet of Things device comprising:
a processor and
a memory coupled to the processor, wherein the processor is capable of executing a plurality of modules stored in the memory, and wherein the plurality of modules comprising:
a data capturing module for capturing dimension data associated to zero or more objects present in a pallet of a plurality of pallets of a pallet rack present in a warehouse, and wherein the dimension data indicates area occupied by the zero or more objects in the pallet;
a surface space computation module for
computing empty surface space in the pallet based on the dimension data and a predefined pallet dimension data associated with the pallet, and
determining whether the empty surface space, in the pallet, is greater or less than a predefined threshold value; and
a data transmission module for transmitting data to an external system communicatively coupled with the Internet of Things device, the data indicating the empty surface space, in the pallet, being greater or less than the predefined threshold value thereby facilitating a user to optimize the space in the pallet of the pallet rack present in the warehouse.

7. The system of claim 6, wherein the Internet of Things device is at least one of a Radio-frequency identification Device, a telematics device, a wearable device, and a sensor

8. The system of claim 6, wherein the empty surface space is computed by subtracting the dimension data from the predefined pallet dimension data.

9. The system of claim 6, wherein the pallet is displayed in green on a Graphical User Interface of the external system when the empty surface space green is greater than the predefined threshold value, and wherein the pallet is displayed in red on the Graphical User Interface when the empty surface space green is less than the predefined threshold value.

10. A non-transitory computer readable medium embodying a program executable in a computing device for facilitating optimization of space in a warehouse, the program comprising a program code:
a program code for capturing dimension data associated to zero or more objects present in a pallet of a plurality of pallets of a pallet rack present in a warehouse, wherein the dimension data indicates area occupied by the zero or more objects in the pallet, wherein the dimension data is captured by an Internet of Things device;
a program code for computing empty surface space in the pallet based on the dimension data and a predefined pallet dimension data associated with the pallet;
a program code for determining whether the empty surface space, in the pallet, is greater or less than a predefined threshold value; and
a program code for transmitting data to an external system communicatively coupled with the Internet of Things device, the data indicating the empty surface space being greater or less than the predefined threshold value thereby facilitating a user to optimize the space in the pallet of the pallet rack present in the warehouse.
